(19) United States
(12) Patent Application Publication
(10) Pub. No.: US 2025/0196576 A1
(43) Pub. Date: Jun. 19, 2025

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Yong Woong Cha, Hwaseong-si (KR); Dongseok Oh, Hwaseong-si (KR); Wan Je Cho, Hwaseong-si (KR); Seong-Bin Jeong, Hwaseong-si (KR); Yeonho Kim, Hwaseong-si (KR); Jae-Eun Jeong, Hwaseong-si (KR); Jae Yeon Kim, Hwaseong-si (KR); Jungha Park, Hwaseong-si (KR)

(73) Assignees: HYUNDAI MOTOR COMPANY, Seoul (KR); KIA CORPORATION, Seoul (KR)

(21) Appl. No.: 18/830,155

(22) Filed: Sep. 10, 2024

(30) Foreign Application Priority Data
Dec. 13, 2023 (KR) 10-2023-0180588

(51) Int. Cl. B60H 1/00

(52) U.S. Cl. CPC B60H 1/00885; B60H 1/00278; B60H 2001/00307; B60H 2001/00928

(57) ABSTRACT

A heat pump system for a vehicle may be configured to adjust a temperature of a vehicle interior by selectively exchanging heat between coolant and thermal energy generated from refrigerant at the time of condensation and evaporation. The system may use the heat-exchanged low-temperature or high-temperature coolant to improve the heating efficiency of the vehicle by selectively using ambient air heat, waste heat of electrical components, and waste heat of a battery module, at the time of heating the vehicle interior. The system may increase the overall travel distance of the vehicle by efficiently adjusting the temperature of the battery module for optimal performance of the battery module.

### CROSS-REFERENCE TO RELATED APPLICATION

This application claims priority to and the benefit of Korean Patent Application No. 10-2023-0180588 filed in the Korean Intellectual Property Office on Dec. 13, 2023, the entire contents of which are incorporated herein by reference.

### BACKGROUND

### (a) Field of the Disclosure

The present disclosure relates to a heat pump system for a vehicle. More particularly, the present disclosure relates to a heat pump system for a vehicle capable of cooling or heating a vehicle interior by selectively using a low-temperature coolant and a high-temperature coolant and by recollecting the waste heat from various heat sources.

### (b) Description of the Related Art

Generally, an air conditioning system for a vehicle includes an air conditioner unit circulating a refrigerant in order to heat or cool an interior of the vehicle.

The air conditioner unit, which is used to maintain the interior of the vehicle at an appropriate temperature regardless of a change in an external temperature, is configured to heat or cool the interior of the vehicle. This is achieved by heat-exchange using a condenser and an evaporator in a process in which a refrigerant discharged by driving a compressor is circulated back to the compressor through the condenser, a receiver drier, an expansion valve, and the evaporator.

In other words, the air conditioner unit lowers the temperature and humidity of the vehicle interior by condensing a high-temperature high-pressure gas-phase refrigerant compressed from the compressor by the condenser, passing the refrigerant through the receiver drier and the expansion valve, and then evaporating the refrigerant in the evaporator in a cooling mode.

Recently, in accordance with a continuous increased interest in energy efficiency and environmental pollution, the development of an environmentally-friendly vehicle capable of substantially substituting for an internal combustion engine vehicle is desired. Environmentally-friendly vehicles are classified into electric vehicles driven using a fuel cell or electricity as a power source and hybrid vehicles driven using an engine and a battery.

Among these environmentally-friendly vehicles, a separate heater is not used, unlike an air conditioner of a typical vehicle. Additionally, an air conditioner used in the environmentally-friendly vehicles is generally called a heat pump system.

Electric vehicles driven by a power source of a fuel cell generate driving force by converting chemical reaction energy between oxygen and hydrogen into electrical energy. In this process, heat energy is generated by a chemical reaction in a fuel cell. Therefore, it is advantageous to secure performance of the fuel cell to effectively remove generated heat.

In addition, hybrid vehicles generate driving force by driving a motor using electricity supplied from a fuel cell as described above or an electrical battery, together with an engine operated by a typical fossil fuel. Therefore, heat generated from the fuel cell or the battery and the motor should be effectively removed in order to secure performance of the motor.

Therefore, in a hybrid vehicle or an electric vehicle according to the related art, a cooling means, a heat pump system, and a battery cooling system, respectively, should be configured as separate closed circuits so as to prevent heat generation of the motor, an electric component, and the battery including a fuel cell.

Therefore, the size and weight of a cooling module disposed at the front of the vehicle are increased. Also, a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain optimal performance of the battery, a plurality of valves for selectively interconnecting connections pipes are employed Thus, noise and vibration due to frequent opening and closing operations of the valves may be introduced into the vehicle interior, thereby deteriorating the ride comfort.

In addition, since a separate heat-exchanger should be employed in order to recollect the waste heat from various heat sources in the heating mode of the vehicle, there is also the disadvantage of increasing manufacturing cost.

The above information disclosed in this Background section is only to enhance understanding of the background of the disclosure. Therefore, the Background section may contain information that does not form the prior art that is already known to a person of ordinary skill in the art.

### SUMMARY

The present disclosure provides a heat pump system for a vehicle configured to adjust a temperature of a vehicle interior. The system does so by selectively exchanging heat between a coolant and thermal energy generated from the refrigerant at the time of condensation and evaporation of the refrigerant and by using the heat-exchanged low-temperature or high-temperature coolant.

The present disclosure provides a heat pump system for a vehicle configured to improve the heating efficiency of the vehicle by selectively using ambient air heat, waste heat of electrical components, and waste heat of a battery module, at the time of heating the vehicle interior. Additionally, the system increases the overall travel distance of the vehicle by efficiently adjusting the temperature of a battery module for optimal performance of the battery module.

A heat pump system for a vehicle may include a valve module having at least one inlet port and at least one outlet port, through which a first coolant is respectively introduced or discharged. The system may also include: a first line having a first end and a second end connected to the valve module to flow the first coolant, and provided with a radiator and an electrical component; a second line having a first end and a second end connected to the valve module to flow the first coolant, and provided with a battery module; a third line having a first end and a second end connected to the valve module to flow the first coolant, and provided with a condenser and a heating core; and a fourth line having a first end and a second end connected to the valve module to flow the first coolant, and provided with a chiller. The valve module may be configured to selectively connect the first to fourth lines based on at least one mode for temperature adjustment of a vehicle interior and temperature adjustment of the battery module and may be configured to control a flowing movement of the first coolant.

A heat pump system may further include a fifth line configured to flow a second coolant and interconnect an evaporator and a cooling core such that the second coolant, cooled while passing through the evaporator, may be selectively supplied to the cooling core.

The at least one mode may include a first mode for cooling the electrical component and the battery module by using the first coolant cooled at the radiator. The at least one mode may include a second mode for cooling the vehicle interior and cooling the electrical component and the battery module. The at least one mode may include a third mode for heating the vehicle interior and heating the battery module while recollecting an ambient air heat and a waste heat of the electrical component. The at least one mode may include a fourth mode for heating the vehicle interior and recollecting the ambient air heat, the waste heat of the electrical component, and the waste heat of the battery module. The at least one mode may include a fifth mode for heating the vehicle interior by using an electric heater and recollecting residual heat of the first coolant while heating the battery module.

In the first mode, the first line, the second line, and the third line may be interconnected by an operation of the valve module such that the first coolant cooled at the radiator may be introduced into the electrical component and the battery module. The fourth line may be closed by the operation of the valve module and the fifth line may be closed.

In the second mode, the first line may be connected to the third line by an operation of the valve module such that the first coolant cooled at the radiator may be introduced into the electrical component and the condenser. The second line may be connected to the fourth line by the operation of the valve module such that the first coolant having passed through the chiller may be supplied to the battery module. The fifth line may be opened such that a low-temperature second coolant having been cooled while passing through the evaporator may be introduced to the cooling core.

In the third mode, the first line may be connected to the fourth line by an operation of the valve module such that the first coolant having passed through the radiator and the electrical component may be introduced into the chiller. The second line may be connected to the third line by the operation of the valve module such that the first coolant having passed through the condenser may be introduced into the battery module. The first coolant, having a temperature that is increased while passing through the condenser, may be introduced into the heating core along the third line.

In the fourth mode, the first line, the second line, and the fourth line may be interconnected by an operation of the valve module such that the first coolant having passed through the radiator, the electrical component, and the battery module may be introduced into the chiller. The third line may form an independent closed circuit by an operation of the valve module such that the first coolant may circulate to sequentially pass through the condenser and the heating core along the third line. The first coolant, having a temperature that is increased while passing through the condenser, may be introduced into the heating core along the third line.

In the fifth mode, the first line may be closed by an operation of the valve module. The second line, the third line, and the fourth line may be interconnected by the operation of the valve module such that the first coolant having passed through the condenser and the electric heater may sequentially pass through the battery module and the chiller. The electric heater may be operated. The first coolant, having a temperature that is increased by the electric heater, may be introduced into the heating core along the third line. The battery module may have a temperature that is increased by the first coolant, having a temperature that is increased while passing through the electric heater. Additionally, the chiller may recollect residual heat remaining in the first coolant having passed through the battery module.

To provide dehumidification of the vehicle interior in the third mode, the fourth mode, and the fifth mode, the fifth line may be opened. Additionally, the second coolant may flow along the fifth line by an operation of a third water pump such that the second coolant having been cooled while passing through the evaporator may be introduced into the cooling core.

The valve module may include: a first port connected to a first end of the first line; a second port connected to a second end of the first line; a third port connected to a first end of the second line; a fourth port connected to a second end of the second line; a third inlet port connected to a first end of the third line; a third outlet port connected to a second end of the third line; a fourth inlet port connected to a first end of the fourth line; and a fourth outlet port connected to a second end of the fourth line.

A heat pump system may further include a first water pump provided on the third line and a second water pump provided on the fourth line.

An electric heater may be further provided on the third line such that the first coolant may sequentially pass through the condenser and the electric heater.

An autonomous driving controller may be provided on the second line.

A third water pump may be provided on the fifth line.

As described above, according to a heat pump system for a vehicle according to an embodiment of the disclosure, the system selectively exchanges heat between the coolant and thermal energy generated from the refrigerant at the time of condensing and evaporating the refrigerant. Additionally, by adjusting the temperature of the vehicle interior by using the heat-exchanged low-temperature or high-temperature coolant, the system may be streamlined and the layout of connection pipes through which refrigerant circulates may be streamlined.

In addition, according to the present disclosure, by selectively using ambient air heat, waste heat of electrical components, and waste heat of battery module, at the time of heating the vehicle interior, the heating efficiency may be improved. Additionally, the overall travel distance of the vehicle may be increased through an efficient temperature adjustment of the battery module for optimal performance of the battery module.

In addition, according to the present disclosure, the temperature of the electrical components and the battery module may be efficiently adjusted through the valve control. Accordingly, the overall marketability of the vehicle may be improved.

In addition, according to the present disclosure, due to the streamlining of the entire system, it is possible to reduce the overall manufacturing cost and weight, thus improving space utilization by minimizing the number of components.

### BRIEF DESCRIPTION OF THE DRAWINGS

FIG. 1 is a block diagram of a heat pump system for a vehicle according to an embodiment of the present disclosure.

FIG. 2 is an operation diagram according to a first mode in a heat pump system for a vehicle according to an embodiment of the present disclosure.

FIG. 3 is an operation diagram according to a second mode in a heat pump system for a vehicle according to an embodiment of the present disclosure.

FIG. 4 is an operation diagram according to a third mode in a heat pump system for a vehicle according to an embodiment of the present disclosure.

FIG. 5 is an operation diagram according to a fourth mode in a heat pump system for a vehicle according to an embodiment of the present disclosure.

FIG. 6 is an operation diagram according to a fifth mode in a heat pump system for a vehicle according to an embodiment of the present disclosure.

### DETAILED DESCRIPTION

Embodiments of the disclosure are hereinafter described in detail with reference to the accompanying drawings.

The embodiments disclosed in the present specification and the constructions depicted in the drawings are only example embodiments of the present disclosure and thus do not cover the entire scope of the present disclosure. Therefore, it should be understood that there may be various equivalents and variations when applying the concepts of this specification.

In order to clarify the present disclosure, parts that are not related to the description have been omitted. Also, the same elements or equivalents are referred to with the same reference numerals throughout the specification.

Also, the size and thickness of each element are arbitrarily shown in the drawings and the present disclosure is not necessarily limited thereto. Additionally, in the drawings, the thickness of layers, films, panels, regions, and the like, may be exaggerated for clarity.

In addition, unless explicitly described to the contrary, the terms “comprise” and variations such as “comprises” or “comprising”, should be understood to imply the inclusion of stated elements but not the exclusion of any other elements. The same understanding should apply to similar terms such as “have,” “include”, and the like.

Furthermore, terms, such as “ . . . unit”, “ . . . means”, “ . . . portions”, “ . . . part”, and “ . . . member” described in the specification, mean a unit of a comprehensive element that performs at least one function or operation.

When a component, device, element, or the like of the present disclosure is described as having a purpose or performing an operation, function, or the like, the component, device, or element should be considered herein as being “configured to” meet that purpose or perform that operation or function.

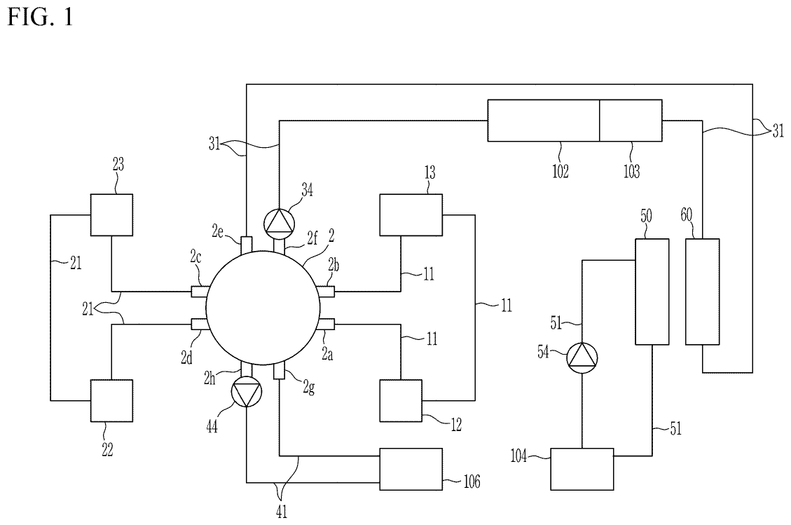

FIG. 1 is a block diagram of a heat pump system for a vehicle according to an embodiment.

A heat pump system for a vehicle according to an embodiment may selectively exchange heat between a coolant and thermal energy generated from the refrigerant at the time of condensing and evaporating a refrigerant. The heat pump system may perform cooling or heating of a vehicle interior by using a low temperature or high-temperature coolant.

In addition, for heating the vehicle interior, the heat pump system may improve heating efficiency of the vehicle by selectively using ambient air heat, waste heat of an electrical component 13, and/or waste heat of a battery module 22. The heat pump system may also efficiently adjust the temperature of the battery module 22 for an optimal performance of the battery module 22, thereby increasing the overall travel distance of the vehicle.

Such a heat pump system may be applied to a hybrid vehicle or an electric vehicle.

Referring to FIG. 1, the heat pump system may include a valve module 2, a first line 11, a second line 21, a third line 31, and a fourth line 41.

First, the valve module 2 may have at least one port through which a first coolant is introduced or discharged, such as at least one inlet port, and at least one outlet port, respectively. The valve module 2 may also control a flowing movement of the introduced first coolant.

The first line 11 may have a first end and a second end connected to the valve module 2, and the first coolant may flow therethrough. A radiator 12 and the electrical component 13 may be provided on the first line 11.

The radiator 12 may be disposed in the front of the vehicle, and a cooling fan may be provided at a downstream side of the radiator 12. Accordingly, the radiator 12 may cool the first coolant through an operation of the cooling fan and exchange heat with the ambient air.

Accordingly, the first coolant cooled at the radiator 12 may circulate along the first line 11 to flow to the valve module 2.

The electrical component 13 may include a power control apparatus, i.e., an electric power control unit (EPCU) including a motor, an on-board charger (OBC), or the like.

The power control apparatus may generate heat while the vehicle is driving. The charger may generate heat when charging the battery module 22.

In other words, at the time of heating the vehicle interior, when the waste heat of the electrical component 13 is to be recollected, the heat generated from the power control apparatus may be recollected and the heat generated from the charger may be recollected at the time of charging the battery module 22.

In the present embodiment, the second line 21 may have a first end and a second end connected to the valve module 2, and the first coolant may flow therethrough. The battery module 22 may be provided on the second line 21. In addition, an autonomous driving controller 23 may be further provided on the second line 21.

The third line 31 may have a first end and a second end connected to the valve module 2, and the first coolant may flow therethrough. A first water pump 34, a condenser 102, an electric heater 103, and a heating core 60 may be provided on the third line 31.

The condenser 102 may be connected to a compressor (not shown) via the refrigerant line. The condenser 102 may condense the refrigerant by exchanging heat between the refrigerant and the first coolant that circulates via the third line 31.

In other words, the condenser 102 may condense the introduced refrigerant through heat-exchange with the first coolant and may increase the temperature of the first coolant by supplying the thermal energy generated while condensing the refrigerant to the first coolant.

The condenser 102 configured as such may be a water-cooled heat-exchanger into which the first coolant is introduced.

The electric heater 103 may be further provided on the third line 31. The electric heater 103 may be provided on the third line 31 separately from the condenser 102 or may be integrally formed with the condenser 102.

The electric heater 103 may selectively heat the first coolant introduced via the third line 31, and thereby increase the temperature of the coolant.

Accordingly, the third line 31 may be connected to the condenser 102 and the electric heater 103 such that the first coolant may sequentially pass through the condenser 102 and the electric heater 103.

In the present embodiment, the fourth line 41 may have a first end and a second end connected to the valve module 2, and the first coolant may flow therethrough. A second water pump 44 and a chiller 106 may be provided on the fourth line 41.

The selectively expanded refrigerant may be introduced into the chiller 106. For cooling the battery module 22 and the autonomous driving controller 23, or for heating the vehicle interior, the chiller 106 may operate in order to recollect heat from the first coolant whose temperature is increased by the ambient air heat, the waste heat of the electrical component 13, or the waste heat of the battery module 22.

The heat pump system may interconnect an evaporator 104 and a cooling core 50 such that a second coolant cooled while passing through the evaporator 104 may be selectively supplied to the cooling core 50. The system may further include a fifth line 51 configured to flow the second coolant.

In addition, a third water pump 54 for flowing the second coolant may be provided on the fifth line 51. The third water pump 54 may be an electric water pump.

The evaporator 104 may be connected to an expansion valve (not shown) via the refrigerant line. The evaporator 104 may evaporate the refrigerant by exchanging heat between the refrigerant and the second coolant circulating the fifth line 51.

In other words, the evaporator 104 may evaporate the introduced refrigerant through heat-exchange with the second coolant and may lower the temperature of the second coolant by supplying a low-temperature thermal energy generated by the evaporation of the refrigerant to the second coolant. The evaporator 104 may be a water-cooled heat-exchanger into which the second coolant is introduced.

Accordingly, when cooling of the vehicle interior is desired, or when dehumidification is desired for heating the vehicle interior, the second coolant cooled while passing through the evaporator 104 may be introduced into the cooling core 50 along the fifth line 51.

The refrigerant may be selectively introduced into the condenser 102, the evaporator 104, and the chiller 106, as described above.

Accordingly, the condenser 102 and the chiller 106 may selectively exchange heat between the first coolant flowing via the third line 31 and the fourth line 41 and the thermal energy generated by condensation and evaporation of the refrigerant.

In addition, the evaporator 104 may selectively perform heat-exchange with the second coolant flowing via the fifth line 51.

Accordingly, a high-temperature first coolant having exchanged heat at the condenser 102 may be introduced into the heating core 60 provided on the third line 31 by a selective an operation of the valve module 2 and the first water pump 34 based on the selected mode of the vehicle.

In addition, a low-temperature second coolant having exchanged heat at the evaporator 104 may be introduced into the cooling core 50 provided on the fifth line 51 by a selective operation of the third water pump 54 based on the selected mode of the vehicle.

In the present embodiment, the cooling core 50 and the heating core 60 may be provided inside a heating, ventilation, and air-conditioning (HVAC) module (not shown).

In other words, the ambient air introduced into the vehicle interior may be converted into the high-temperature state or the low-temperature state while having exchanged heat with the low-temperature second coolant or the high-temperature first coolant introduced into at least one of the cooling core 50 or the heating core 60 by an operation of a blower-fan (not shown).

The ambient air of high temperature or low temperature may be introduced into the vehicle interior, thereby cooling or heating the vehicle interior.

In the present embodiment, the valve module 2 may be an 8-way valve having four ports through which the first coolant is introduced or discharged, i.e., four inlet ports and four outlet ports. The valve module 2 is described below in more detail.

The valve module 2 may include a first port 2a, a second port 2b, a third port 2c, and a fourth port 2d, a third inlet port 2e, a third outlet port 2f, a fourth inlet port 2g, and a fourth outlet port 2h.

First, a first end of the first line 11 may be connected to the first port 2a of the valve module 2. A second end of the first line 11 may be connected to the second port 2b of the valve module 2.

A first end of the second line 21 may be connected to the third port 2c of the valve module 2. A second end of the second line 21 may be connected to the fourth port 2d of the valve module 2.

A first end of the third line 31 may be connected to the third inlet port 2e of the valve module 2. A second end of the third line 31 may be connected to the third outlet port 2f of the valve module 2.

In addition, a first end of the fourth line 41 may be connected to the fourth inlet port 2g of the valve module 2. A second end of the fourth line 41 may be connected to the fourth outlet port 2h of the valve module 2.

The present embodiment has been described such that the valve module 2 is an 8-way valve having eight ports through which the first coolant is introduced or discharged, i.e., four inlet ports through which the first coolant is introduced and four outlet ports through which the first coolant is discharged but is not limited thereto. Additionally, the valve module 2 may include more ports such that a separate component circulating the first coolant may be connected.

The valve module 2 configured as such may operate to selectively interconnect the first to fourth lines 11, 21, 31, and 41 depending on at least one mode for temperature adjustment of the vehicle interior and temperature adjustment of the battery module 22, and thereby control a flowing movement of the coolant.

The at least one mode may include a first mode to a fifth mode.

First, in the first mode, the electrical component 13 and the battery module 22 may be cooled by using the first coolant cooled at the radiator 12.

In the second mode, the vehicle interior may be cooled, and the electrical component 13 and the battery module 22 may be cooled.

In the third mode, the vehicle interior may be heated, and the battery module 22 may be heated while recollecting the ambient air heat and the waste heat of the electrical component 13.

In the fourth mode, the vehicle interior may be heated, and the ambient air heat, the waste heat of the electrical component 13, and the waste heat of the battery module 22 may be recollected.

In addition, in the fifth mode, the vehicle interior may be heated by using the electric heater 103, and a residual heat of the coolant may be recollected while heating the battery module 22.

When dehumidification of the vehicle interior is desired in the third mode, the fourth mode, and the fifth mode, the fifth line 51 may be opened.

Accordingly, the second coolant may flow along the fifth line 51 by the operation of the third water pump 54 such that the second coolant having been cooled while passing through the evaporator 104 may be introduced into the cooling core 50.

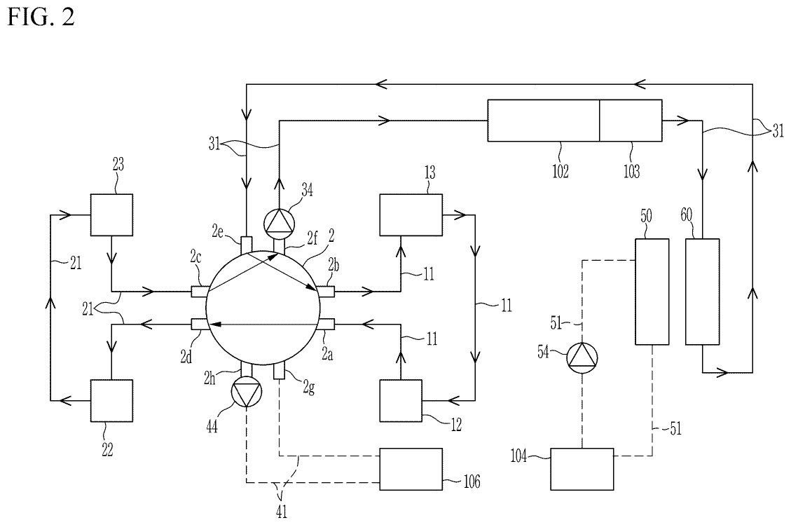

Hereinafter, an operation and action for each mode of a heat pump system for a vehicle according to an embodiment configured as described above is described in detail with reference to FIGS. 2-6.

First, in a heat pump system for a vehicle according to an embodiment, the operation according to the first mode for cooling the electrical component 13 and the battery module 22 by using the first coolant cooled at the radiator 12 is described with reference to FIG. 2.

FIG. 2 is an operation diagram according to the first mode in a heat pump system for a vehicle according to an embodiment.

Referring to FIG. 2, the refrigerant may not be supplied to the condenser 102, the evaporator 104, and the chiller 106.

In addition, the first line 11, the second line 21, and the third line 31 may be interconnected by an operation of the valve module 2 such that the first coolant cooled at the radiator 12 may be introduced into the electrical component 13 and the battery module 22.

Simultaneously, the fourth line 41 may be closed by the operation of the valve module 2.

The fifth line 51 may be closed, and the operation of the third water pump 54 may be stopped.

Accordingly, the first coolant cooled at the radiator 12 may be introduced into the first port 2a of the valve module 2 along the first line 11 by an operation of the first water pump 34.

The first coolant introduced into the first port 2a of the valve module 2 may be discharged to the second line 21 connected to the fourth port 2d of the valve module 2 by the operation of the valve module 2.

The first coolant discharged to the second line 21 may sequentially pass through the battery module 22 and the autonomous driving controller 23. Thereafter, the first coolant may be introduced into the third port 2c of the valve module 2.

The first coolant introduced into the third port 2c of the valve module 2 may be discharged to the third line 31 connected to the third outlet port 2f of the valve module 2 by the operation of the valve module 2.

The first coolant discharged to the third line 31 may sequentially pass through the condenser 102, the electric heater 103, and the heating core 60 along the third line 31. The electric heater 103 may not be operated.

The first coolant flowing via the third line 31 may be introduced into the third inlet port 2e of the valve module 2.

The first coolant introduced into the third inlet port 2e of the valve module 2 may be supplied to the electrical component 13 along the first line 11 while being discharged to the second port 2b of the valve module 2 by the operation of the valve module 2.

In other words, in the first mode, the first line 11, the second line 21, and the third line 31 may form one closed circuit through which the coolant circulates by the operation of the valve module 2.

In such a state, the first coolant may circulate along the first line 11, the second line 21, and the third line 31 that are interconnected by the operation of the first water pump 34.

In other words, the first coolant cooled at the radiator 12 may circulate along the first line 11, the second line 21, and the third line 31 while repeatedly performing the above-described operation.

Accordingly, the electrical component 13, the battery module 22, and the autonomous driving controller 23 may be efficiently cooled by the first coolant cooled at the radiator 12.

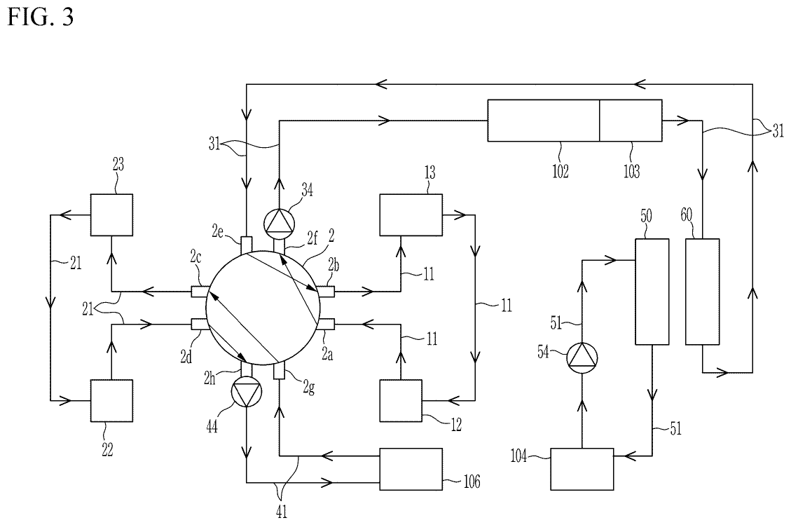

In a heat pump system for a vehicle according to an embodiment, the operation according to the second mode for cooling the vehicle interior and cooling the electrical component 13 and the battery module 22 is described with reference to FIG. 3.

FIG. 3 is an operation diagram according to the second mode in a heat pump system for a vehicle according to an embodiment.

Referring to FIG. 3, the refrigerant may circulate through the condenser 102, the evaporator 104, and the chiller 106. At this time, the expanded refrigerant may be supplied to each of the evaporator 104 and the chiller 106.

In addition, the first line 11 may be connected to the third line 31 by the operation of the valve module 2 such that the first coolant cooled at the radiator 12 may be introduced into the electrical component 13 and the condenser 102.

Accordingly, the first coolant cooled at the radiator 12 may be introduced into the first port 2a of the valve module 2 along the first line 11 by the operation of the first water pump 34.

The first coolant introduced into the first port 2a of the valve module 2 may be discharged to the third line 31 connected to the third outlet port 2f of the valve module 2 by the operation of the valve module 2.

The first coolant discharged to the third line 31 may sequentially pass through the condenser 102 and the electric heater 103, and then pass through the heating core 60. The condenser 102 may condense the refrigerant by using the first coolant flowing along the third line 31. At this time, the electric heater 103 is not operated.

Then, the first coolant having passed through the heating core 60 may be introduced into the third inlet port 2e of the valve module 2 along the third line 31.

The first coolant introduced into the third inlet port 2e of the valve module 2 may be discharged to the second port 2b of the valve module 2 and may be supplied to the electrical component 13 along the first line 11.

Accordingly, the electrical component 13 may be efficiently cooled by the coolant cooled at the radiator 12.

In other words, in the second mode, the first line 11 and the third line 31 may form one closed circuit through which the first coolant circulates by the operation of the valve module 2.

In such a state, the first coolant may circulate along the first line 11 and the third line 31 interconnected by the operation of the first water pump 34.

The second line 21 may be connected to the fourth line 41 by the operation of the valve module 2. Thus, the first coolant cooled through heat-exchange with the refrigerant while passing through the chiller 106 may be supplied to the battery module 22 and the autonomous driving controller 23.

In other words, the first coolant introduced from the chiller 106 into the fourth inlet port 2g of the valve module 2 along the fourth line 41 may be discharged to the second line 21 connected to the third port 2c of the valve module 2 by the operation of the valve module 2.

The coolant discharged to the second line 21 may pass through the autonomous driving controller 23 and the battery module 22 and then may be introduced into the fourth port 2d of the valve module 2 along the second line 21.

Then, the first coolant introduced into the fourth port 2d of the valve module 2 may be discharged to the fourth line 41 connected to the fourth outlet port 2h of the valve module 2 by the operation of the valve module 2.

The first coolant discharged to the fourth line 41 may pass through the chiller 106, and then may be introduced again into the fourth inlet port 2g of the valve module 2.

In other words, in the second mode, the second line 21 and the fourth line 41 may form another closed circuit through which the first coolant circulates by the operation of the valve module 2.

In such a state, the first coolant may circulate along the second line 21 and the fourth line 41 interconnected by an operation of the second water pump 44.

At this time, the chiller 106 may cool the coolant by exchanging heat between the first coolant introduced via the fourth line 41 with the refrigerant.

Therefore, the first coolant cooled at the chiller 106 may efficiently cool the battery module 22 and the autonomous driving controller 23 while circulating via the second line 21 and the fourth line 41 interconnected with each other.

In addition, the fifth line 51 may be opened such that the low-temperature second coolant having been cooled while passing through the evaporator 104 may be introduced into the cooling core 50.

In such a state, when the third water pump 54 is operated, the evaporator 104 may cool the second coolant circulating along the fifth line 51 through heat-exchange with a low-temperature refrigerant and may evaporate the refrigerant.

Accordingly, the low-temperature second coolant cooled while passing through the evaporator 104 may flow along the fifth line 51 and pass through the cooling core 50.

In other words, the low-temperature second coolant cooled at the evaporator 104 may circulate along the fifth line 51 through the operation of the third water pump 54 and may be supplied to the cooling core 50.

An opening/closing door (not shown) may be provided between the cooling core 50 and the heating core 60. The opening/closing door may close a side toward the heating core 60 such that the ambient air having been cooled while passing through the cooling core 50 may be directly introduced into the vehicle.

In such a state, the ambient air introduced into the vehicle interior may be cooled while having exchanged heat with the low-temperature second coolant supplied to the cooling core 50 by the operation of the blower-fan (not shown). Thereafter, the cooled ambient air may be directly introduced into the vehicle interior, thereby efficiently cooling the vehicle interior.

In addition, when dehumidification is desired while cooling the vehicle interior, opening/closing door (not shown) may open a portion passing through the heating core 60 such that the ambient air having been cooled while passing through the cooling core 50 may pass through the heating core 60.

Accordingly, the ambient air introduced into the vehicle interior may be cooled while having exchanged heat with the low-temperature second coolant supplied to the cooling core 50 by the operation of the blower-fan (not shown). Thereafter, the cooled ambient air may be dehumidified while passing through the heating core 60 and introduced into the vehicle interior, thereby smoothly cooling and dehumidifying the vehicle interior.

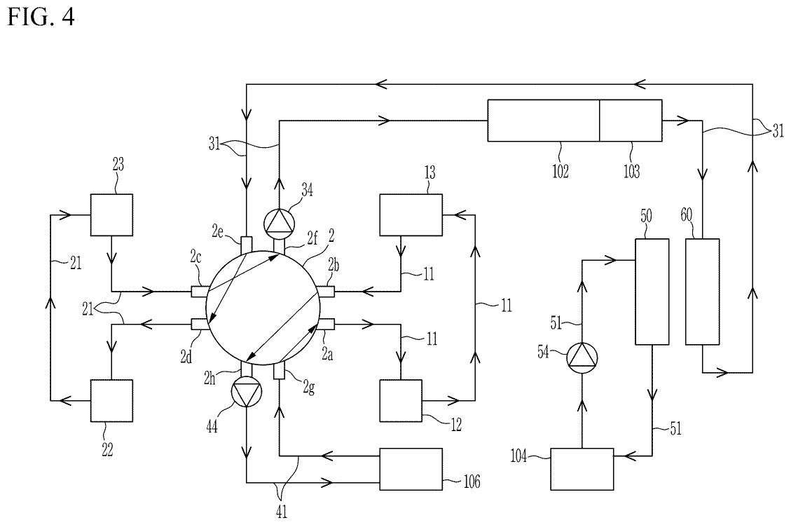

In a heat pump system for a vehicle according to an embodiment, the operation according to the third mode for heating the vehicle interior, recollecting the ambient air heat and the waste heat of the electrical component 13, and heating the battery module 22 is described with reference to FIG. 4.

FIG. 4 is an operation diagram according to the third mode in a heat pump system for a vehicle according to an embodiment.

Referring to FIG. 4, the refrigerant may circulate through the condenser 102 and the chiller 106. At this time, the expanded refrigerant may be supplied to the chiller 106.

In addition, the first line 11 may be connected to the fourth line 41 by the operation of the valve module 2. Thus, the first coolant having passed through the radiator 12 and the electrical component 13 may be introduced into the chiller 106.

Accordingly, the first coolant may recollect the ambient air heat through heat-exchange with the ambient air while passing through the radiator 12 and may absorb the waste heat from the electrical component 13 to increase its temperature.

The first coolant whose temperature is increased may be introduced into the second port 2b of the valve module 2 along the first line 11 by the operation of the second water pump 44.

The first coolant introduced into the second port 2b of the valve module 2 may be discharged to the fourth line 41 connected to the fourth outlet port 2h of the valve module 2 by the operation of the valve module 2.

The first coolant discharged to the fourth line 41 may be supplied to the chiller 106. Therefore, the ambient air heat recollected at the radiator 12 and the waste heat generated at the electrical component 13 may increase the temperature of the refrigerant supplied to the chiller 106.

In other words, the chiller 106 may be used to increase the temperature of the refrigerant by recollecting the ambient air heat and the waste heat of the electrical component 13 through heat-exchange between the first coolant and the refrigerant.

Then, the first coolant having passed through the chiller 106 may be introduced into the fourth inlet port 2g of the valve module 2 along the fourth line 41.

The first coolant introduced into the fourth inlet port 2g of the valve module 2 may be discharged to the first line 11 connected to the first port 2a of the valve module 2 by the operation of the valve module 2.

The first coolant discharged to the first line 11 may sequentially pass through the radiator 12 and the electrical component 13 and then may flow back into the valve module 2, thereby repeatedly performing the above-described processes.

In other words, in the third mode, the first line 11 and the fourth line 41 may form one closed circuit through which the first coolant circulates by the operation of the valve module 2.

In such a state, the first coolant may circulate along the first line 11 and the fourth line 41 interconnected by the operation of the second water pump 44.

In the third mode, the fifth line 51 may be closed, and the operation of the third water pump 54 may be stopped.

Simultaneously, the second line 21 may be connected to the third line 31 by the operation of the valve module 2 such that the first coolant whose temperature is increased while passing through the condenser 102 may be introduced into the battery module 22.

Accordingly, the first coolant having passed through the battery module 22 and the autonomous driving controller 23 by the operation of the first water pump 34 may be introduced into the third port 2c of the valve module 2 along the second line 21.

The first coolant introduced into the third port 2c of the valve module 2 may then be discharged to the third line 31 connected to the third outlet port 2f of the valve module 2 by the operation of the valve module 2.

The first coolant discharged to the third line 31 may sequentially pass through the condenser 102 and the electric heater 103. The condenser 102 may condense the refrigerant by using the first coolant flowing along the third line 31.

At this time, the temperature of the first coolant may be increased while condensing the refrigerant at the condenser 102. The first coolant whose temperature is increased while passing through the condenser 102 may be introduced into the heating core 60 along the third line 31.

In such a state, the ambient air introduced into the vehicle interior may be converted into the high-temperature state while having exchanged heat with the high-temperature first coolant supplied to the heating core 60 by the operation of the blower-fan (not shown). Thereafter, the ambient air in the high-temperature state may be introduced into the vehicle interior, thereby achieving heating of the vehicle interior.

In other words, according to a heat pump system according to the present embodiment, for heating the vehicle interior, by absorbing the ambient air heat and the waste heat of the electrical component 13 by the chiller 106 and using it to increase the temperature of the refrigerant, the power consumption of the compressor may be reduced, and the heating efficiency may be improved.

The first coolant having passed through the heating core 60 may flow along the third line 31 and may be introduced into the third inlet port 2e of the valve module 2.

The first coolant introduced into the third inlet port 2e of the valve module 2 may be discharged to the second line 21 connected to the fourth port 2d of the valve module 2 by the operation of the valve module 2.

The first coolant discharged to the second line 21 may increase the temperature of the battery module 22 while passing through the battery module 22.

In other words, through such an operation, the battery module 22 may efficiently increase its temperature as the first coolant whose temperature is increased is supplied.

As such, in the third mode, the second line 21 and the third line 31 may form another closed circuit through which the first coolant circulates by the operation of the valve module 2.

In such a state, the first coolant may circulate along the second line 21 and the third line 31 interconnected by the operation of the first water pump 34.

In other words, when heating of the battery module 22 is desired, the heat pump system may supply the first coolant whose temperature is increased while passing through the condenser 102 to the battery module 22, thereby efficiently increasing the temperature of the battery module 22.

When dehumidification is desired while heating the vehicle interior, the expanded refrigerant may be supplied to the evaporator 104. Accordingly, the fifth line 51 may be opened such that the low-temperature second coolant having been cooled while passing through the evaporator 104 may be introduced into the cooling core 50.

In such a state, when the third water pump 54 is operated, the evaporator 104 may cool the second coolant circulating along the fifth line 51 through heat-exchange with the low-temperature refrigerant and may evaporate the refrigerant.

Accordingly, the low-temperature second coolant cooled while passing through the evaporator 104 may flow along the fifth line 51 and pass through the cooling core 50.

In other words, the low-temperature second coolant cooled at the evaporator 104 may circulate along the fifth line 51 through the operation of the third water pump 54 and may be supplied to the cooling core 50.

In such a state, the opening/closing door (not shown) may open a portion passing through the heating core 60 such that the ambient air having been cooled while passing through the cooling core 50 may pass through the heating core 60.

Accordingly, the ambient air introduced into the vehicle interior may be dehumidified while having exchanged heat with the low-temperature second coolant supplied to the cooling core 50 by the operation of the blower-fan (not shown).

Then, the dehumidified ambient air may be converted into the high-temperature state while passing through the heating core 60 and then introduced into the vehicle interior, thereby smoothly heating and dehumidifying the vehicle interior.

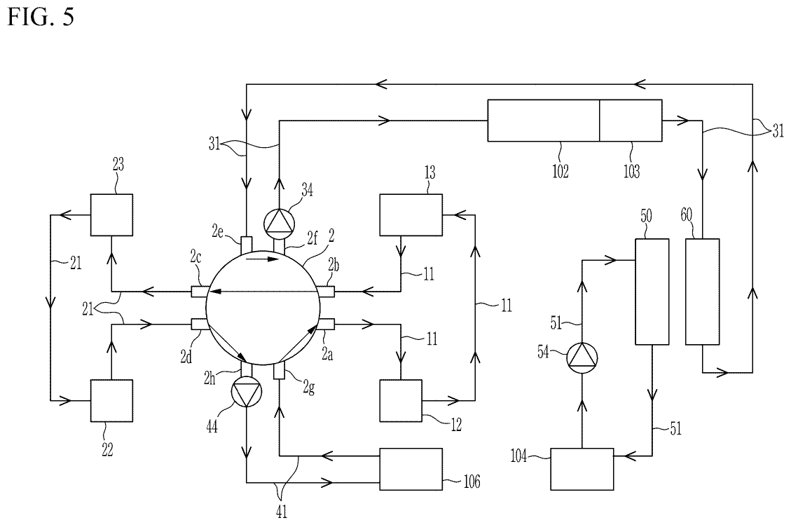

In a heat pump system for a vehicle according to an embodiment, the operation according to the fourth mode for heating the vehicle interior and recollecting the ambient air heat, the waste heat of the electrical component 13, and the waste heat of the battery module 22 is described with reference to FIG. 5.

FIG. 5 is an operation diagram according to the fourth mode in a heat pump system for a vehicle according to an embodiment.

Referring to FIG. 5, the refrigerant may circulate through the condenser 102 and the chiller 106. At this time, the expanded refrigerant may be supplied to the chiller 106.

In addition, the first line 11, the second line 21, and the fourth line 41 may be interconnected by the operation of the valve module 2. Thus, the first coolant having passed through the radiator 12, the electrical component 13, and the battery module 22 may be introduced into the chiller 106.

Accordingly, the first coolant may recollect the ambient air heat through heat-exchange with the ambient air while passing through the radiator 12 and may absorb the waste heat from the electrical component 13 to increase its temperature.

The first coolant whose temperature is increased may be introduced into the second port 2b of the valve module 2 along the first line 11 by the operation of the second water pump 44.

The first coolant introduced into the second port 2b of the valve module 2 may be discharged to the second line 21 connected to the third port 2c of the valve module 2 by the operation of the valve module 2.

The first coolant discharged to the second line 21 may pass through the autonomous driving controller 23 and the battery module 22 and then may be introduced into the fourth port 2d of the valve module 2 along the second line 21.

The first coolant may absorb waste heat from the battery module 22 while passing through the battery module 22, thereby further increasing its temperature.

Then, the coolant introduced into the fourth port 2d of the valve module 2 may be discharged to the fourth line 41 connected to the fourth outlet port 2h of the valve module 2 by the operation of the valve module 2.

The first coolant discharged to the fourth line 41 may be supplied to the chiller 106. Therefore, the ambient air heat recollected at the radiator 12, the waste heat generated at the electrical component 13, and the waste heat generated at the battery module 22 may increase the temperature of the refrigerant supplied to the chiller 106.

In other words, the chiller 106 may be used to increase the temperature of the refrigerant by recollecting the ambient air heat, the waste heat of the electrical component 13, and the waste heat of the battery module 22 through heat-exchange between the first coolant and the refrigerant.

Then, the first coolant having passed through the chiller 106 may be introduced into the fourth inlet port 2g of the valve module 2 along the fourth line 41.

The first coolant introduced into the fourth inlet port 2g of the valve module 2 may be discharged to the first line 11 connected to the first port 2a of the valve module 2 by the operation of the valve module 2.

The first coolant discharged to the first line 11 may sequentially pass through the radiator 12 and the electrical component 13, and then flow back into the valve module 2, thereby repeatedly performing the above-described processes.

In other words, in the fourth mode, the first line 11, the second line 21, and the fourth line 41 may form one closed circuit through which the first coolant circulates by the operation of the valve module 2.

In such a state, the first coolant may circulate along the first line 11, the second line 21, and the fourth line 41 that are interconnected by the operation of the second water pump 44.

In the fourth mode, the fifth line 51 may be closed, and the operation of the third water pump 54 may be stopped.

Simultaneously, the third line 31 may form an independent closed circuit by the operation of the valve module 2 such that the first coolant may circulate to sequentially pass through the condenser 102 and the heating core 60 along the third line 31.

In other words, the first coolant introduced into the third inlet port 2e of the valve module 2 via the third line 31 may be discharged to the third outlet port 2f of the valve module 2 by an operation of the first water pump 34 and the valve module 2.

Then, the first coolant circulating along the third line 31 may sequentially pass through the condenser 102 and the electric heater 103. The condenser 102 may condense the refrigerant by using the first coolant flowing along the third line 31.

At this time, the temperature of the first coolant may be increased while condensing the refrigerant at the condenser 102. The first coolant whose temperature is increased while passing through the condenser 102 may be introduced into the heating core 60 along the third line 31.

In such a state, the ambient air introduced into the vehicle interior may be converted into the high-temperature state while having exchanged heat with the high-temperature first coolant supplied to the heating core 60 by the operation of the blower-fan (not shown).

Then, the ambient air in the high-temperature state may be introduced into the vehicle interior, thereby achieving heating of the vehicle interior.

In other words, according to a heat pump system according to the present embodiment, for heating the vehicle interior, the ambient air heat, the waste heat of the electrical component 13, and by absorbing the waste heat of the battery module 22 by the chiller 106 and using it to increase the temperature of the refrigerant, the power consumption of the compressor may be reduced and the heating efficiency may be improved.

The first coolant having passed through the heating core 60 may flow along the third line 31 and then may flow into the third inlet port 2e of the valve module 2, thereby repeatedly performing the above-described processes.

When dehumidification is desired while heating the vehicle interior, the expanded refrigerant may be supplied to the evaporator 104. Accordingly, the fifth line 51 may be opened such that the low-temperature second coolant having been cooled while passing through the evaporator 104 may be introduced into the cooling core 50.

In such a state, when the third water pump 54 is operated, the evaporator 104 may cool the second coolant circulating along the fifth line 51 through heat-exchange with the low-temperature refrigerant and may evaporate the refrigerant.

Accordingly, the low-temperature second coolant cooled while passing through the evaporator 104 may flow along the fifth line 51 and pass through the cooling core 50.

In other words, the low-temperature second coolant cooled at the evaporator 104 may circulate along the fifth line 51 through the operation of the third water pump 54 and may be supplied to the cooling core 50.

In such a state, the opening/closing door (not shown) may open a portion passing through the heating core 60 such that the ambient air having been cooled while passing through the cooling core 50 may pass through the heating core 60.

Accordingly, the ambient air introduced into the vehicle interior may be dehumidified while having exchanged heat with the low-temperature second coolant supplied to the cooling core 50 by the operation of the blower-fan (not shown).

Then, the dehumidified ambient air may be converted into the high-temperature state while passing through the heating core 60 and then may be introduced into the vehicle interior, thereby smoothly heating and dehumidifying the vehicle interior.

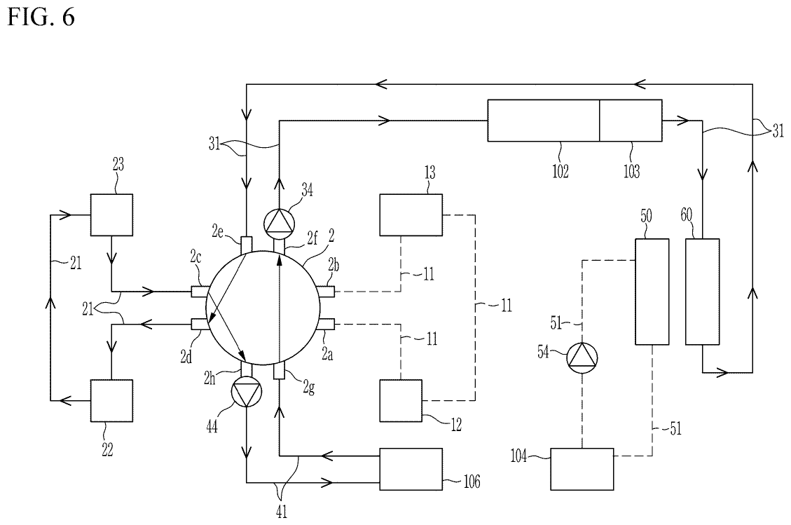

In addition, in a heat pump system for a vehicle according to an embodiment, the operation according to the fifth mode for heating the vehicle interior by using the electric heater 103 and recollecting a residual heat of the first coolant while heating the battery module 22 is described with reference to FIG. 6.

FIG. 6 is an operation diagram according to the fifth mode in a heat pump system for a vehicle according to an embodiment.

Referring to FIG. 6, the refrigerant may circulate through the condenser 102 and the chiller 106. At this time, the refrigerant may not be supplied to the evaporator 104, and the expanded refrigerant may be supplied to the chiller 106.

The first line 11 may be closed by the operation of the valve module 2. At the same time, the fifth line 51 may be closed.

In such a state, the second line 21, the third line 31, and the fourth line 41 may be interconnected by the operation of the valve module 2. Thus, the first coolant having passed through the condenser 102 and the electric heater 103 may sequentially pass through the battery module 22 and the chiller 106.

The first water pump 34, the second water pump 44, and the electric heater 103 may be operated.

Accordingly, the first coolant whose temperature is increased while passing through the electric heater 103 may pass through the heating core 60 along the third line 31 and then may be introduced into the third inlet port 2e of the valve module 2.

The first coolant introduced into the third inlet port 2e of the valve module 2 may be discharged to the second line 21 connected to the fourth port 2d of the valve module 2 by the operation of the valve module 2.

The first coolant discharged to the second line 21 may increase the temperature of the battery module 22 while passing through the battery module 22.

Then, the first coolant having passed through the battery module 22 and the autonomous driving controller 23 may be introduced into the third port 2c of the valve module 2 along the second line 21.

The first coolant introduced into the third port 2c of the valve module 2 may be discharged to the fourth line 41 connected to the fourth outlet port 2h of the valve module 2 by the operation of the valve module 2.

The first coolant discharged to the fourth line 41 may be supplied to the chiller 106. At this time, the chiller 106 may increase the temperature of the refrigerant by using the residual heat remaining in the first coolant having passed through the battery module 22.

In other words, the chiller 106 may be used to increase the temperature of the refrigerant by recollecting the residual heat of the first coolant through heat-exchange between the first coolant and the refrigerant.

The refrigerant evaporated at the chiller 106 may be introduced into the compressor and the refrigerant compressed at the compressor may be supplied to the condenser 102. Accordingly, the refrigerant supplied to the condenser 102 may increase the temperature of the first coolant while having exchanged heat with the first coolant introduced via the third line 31.

The first coolant having passed through the chiller 106 may be introduced into the fourth inlet port 2g of the valve module 2 along the fourth line 41.

The first coolant introduced into the fourth inlet port 2g of the valve module 2 may be discharged to the third line 31 connected to the third outlet port 2f of the valve module 2 by the operation of the valve module 2.

The first coolant discharged to the third line 31 may pass through the condenser 102 and the electric heater 103 and then may be introduced into the heating core 60 along the third line 31.

In addition, the first coolant having passed through the heating core 60 may flow back into the valve module 2 along the third line 31, thereby repeatedly performing the above-described processes.

In other words, in the fifth mode, the second line 21, the third line 31, and the fourth line 41 may form one closed circuit through which the first coolant circulates by the operation of the valve module 2.

In such a state, the first coolant may circulate along the second line 21, the third line 31, and the fourth line 41 interconnected by an operation of the first and second water pumps 34 and 44.

The electric heater 103 may heat the introduced first coolant. At the same time, the condenser 102 may heat the introduced first coolant, together with the electric heater 103.

In other words, for increasing the temperature of the first coolant, the electric heater 103 may perform a main role and the condenser 102 may perform an auxiliary role. By such an operation, the temperature of the first coolant may be increased.

The first coolant whose temperature is increased may be introduced into the heating core 60 along the third line 31.

In such a state, the ambient air introduced into the vehicle interior may be converted into the high-temperature state while having exchanged heat with the high-temperature first coolant supplied to the heating core 60 by the operation of the blower-fan (not shown). Thereafter, the ambient air in the high-temperature state may be introduced into the vehicle interior, thereby achieving heating of the vehicle interior.

In addition, the heat pump system may supply the first coolant having a temperature that is increased while passing through the electric heater 103 to the battery module 22 in order to heat the battery module 22, thereby efficiently increasing the temperature of the battery module 22.

In addition, the heat pump system may recollect the residual heat of the first coolant having heated the battery module 22 by the chiller 106 and may minimize the usage of the electric heater 103 by using the condenser 102 as an auxiliary means for heating the first coolant.

As described above, when a heat pump system for a vehicle according to an embodiment is applied, by selectively exchanging heat between the thermal energy generated from the refrigerant when condensing and evaporating the refrigerant and the first coolant and the second coolant, and by adjusting a temperature of the vehicle interior by using each of the high-temperature first coolant or the low-temperature second coolant having been heat-exchanged, the entire system may be streamlined and the layout of connection pipes through which the refrigerant circulates may be streamlined.

In addition, according to the present disclosure, for heating the vehicle interior, the heating efficiency of the vehicle may be improved by selectively using ambient air heat, waste heat of the electrical component 13, and waste heat of the battery module 22. The overall travel distance of the vehicle may be increased through efficient temperature adjustment of the battery module 22, such that the battery module 22 may exhibit optimal performance.

In addition, according to the present disclosure, the temperature of the electrical component 13 and the battery module 22 may be efficiently adjusted by controlling the valve module 2. As a result, the overall marketability of the vehicle may be improved.

In addition, according to the present disclosure, due to streamlining of the entire system, it is possible to reduce the overall manufacturing cost and weight, and to improve space utilization by minimizing the number of components.

While this disclosure has been described in connection with what are presently considered to be practical embodiments, it is to be understood that the disclosure is not limited to the disclosed embodiments. On the contrary, the disclosure is intended to cover various modifications and equivalent arrangements included within the spirit and scope of the appended claims.

### DESCRIPTION OF SYMBOLS

2: valve module
11: first line
12: radiator
13: electrical component
21: second line
22: battery module
23: autonomous driving controller
31: third line
34: first water pump
41: fourth line
44: second water pump
50: cooling core
51: fifth line
54: third water pump
60: heating core
102: condenser
103: electric heater
104: evaporator
106: chiller

What is claimed is:

1. A heat pump system for a vehicle, comprising:
a valve module having at least one inlet port and at least one outlet port, through which a first coolant is respectively introduced or discharged;
a first line having a first end and a second end connected to the valve module to flow the first coolant, the first line provided with a radiator and an electrical component;
a second line having a first end and a second end connected to the valve module to flow the first coolant, the second line provided with a battery module;
a third line having a first end and a second end connected to the valve module to flow the first coolant, the third line provided with a condenser and a heating core; and
a fourth line having a first end and a second end connected to the valve module to flow the first coolant, the fourth line provided with a chiller,
wherein the valve module is configured to selectively connect the first to fourth lines based on at least one mode for temperature adjustment of a vehicle interior and temperature adjustment of the battery module and is configured to control a flowing movement of the first coolant.

2. The heat pump system of claim 1, further comprising a fifth line configured to flow a second coolant and interconnect an evaporator and a cooling core such that the second coolant is cooled while passing through the evaporator and is selectively supplied to the cooling core.

3. The heat pump system of claim 2, wherein the at least one mode comprises:
a first mode for cooling the electrical component and the battery module by using the first coolant cooled at the radiator;
a second mode for cooling the vehicle interior and cooling the electrical component and the battery module;
a third mode for heating the vehicle interior and heating the battery module while recollecting ambient air heat and waste heat of the electrical component;
a fourth mode for heating the vehicle interior and recollecting the ambient air heat, the waste heat of the electrical component, and waste heat of the battery module; and
a fifth mode for heating the vehicle interior by using an electric heater and recollecting residual heat of the first coolant while heating the battery module.

4. The heat pump system of claim 3, wherein, in the first mode:
the first line, the second line, and the third line are interconnected by an operation of the valve module such that the first coolant cooled at the radiator is introduced into the electrical component and the battery module;
the fourth line is closed by the operation of the valve module; and
the fifth line is closed.

5. The heat pump system of claim 3, wherein, in the second mode:
the first line is connected to the third line by an operation of the valve module such that the first coolant cooled at the radiator is introduced into the electrical component and the condenser;
the second line is connected to the fourth line by the operation of the valve module such that the first coolant having passed through the chiller is supplied to the battery module; and
the fifth line is opened such that a low-temperature second coolant having been cooled while passing through the evaporator is introduced to the cooling core.

6. The heat pump system of claim 3, wherein, in the third mode:
the first line is connected to the fourth line by an operation of the valve module such that the first coolant having passed through the radiator and the electrical component is introduced into the chiller;
the second line is connected to the third line by the operation of the valve module such that the first coolant having passed through the condenser is introduced into the battery module; and
a temperature of the first coolant having been increased while passing through the condenser is introduced into the heating core along the third line.

7. The heat pump system of claim 3, wherein, in the fourth mode:
the first line, the second line, and the fourth line are interconnected by an operation of the valve module such that the first coolant having passed through the radiator, the electrical component, and the battery module is introduced into the chiller;
the third line forms an independent closed circuit by the operation of the valve module such that the first coolant may circulate to sequentially pass through the condenser and the heating core along the third line; and
a temperature of the first coolant having been increased while passing through the condenser is introduced into the heating core along the third line.

8. The heat pump system of claim 3, wherein, in the fifth mode:
the first line is closed by an operation of the valve module;
the second line, the third line, and the fourth line are interconnected by an operation of the valve module such that the first coolant having passed through the condenser and the electric heater may sequentially pass through the battery module and the chiller;
the electric heater is operated;
a temperature of the first coolant having been increased by the electric heater is introduced into the heating core along the third line;
a temperature of the battery module is increased by the temperature of the first coolant having passed through the electric heater; and
the chiller recollects residual heat remaining in the first coolant having passed through the battery module.

9. The heat pump system of claim 3, wherein, to provide dehumidification of the vehicle interior in the third mode, the fourth mode, and the fifth mode:
the fifth line is opened; and
the second coolant flows along the fifth line by an operation of a third water pump such that the second coolant having been cooled while passing through the evaporator is introduced into the cooling core.

10. The heat pump system of claim 1, wherein the valve module comprises:
a first port connected to a first end of the first line;
a second port connected to a second end of the first line;
a third port connected to a first end of the second line;
a fourth port connected to a second end of the second line;
a third inlet port connected to a first end of the third line;
a third outlet port connected to a second end of the third line;
a fourth inlet port connected to a first end of the fourth line; and
a fourth outlet port connected to a second end of the fourth line.

11. The heat pump system of claim 1, further comprising:
a first water pump provided on the third line; and
a second water pump provided on the fourth line.

12. The heat pump system of claim 1, wherein an electric heater is further provided on the third line such that the first coolant may sequentially pass through the condenser and the electric heater.

13. The heat pump system of claim 1, wherein an autonomous driving controller is provided on the second line.

14. The heat pump system of claim 2, wherein a third water pump is provided on the fifth line.
